(19) United States
(12) Patent Application Publication
(10) Pub. No.: US 2020/0399859 A1
(43) Pub. Date: Dec. 24, 2020

(54) Hydraulic Accumulator Assembly

(71) Applicant: DEERE & COMPANY, Moline, IL (US)

(72) Inventors: Kyle A. Holl, Durango, IA (US); Derek S. Hall, Platteville, WI (US); Adam Zell, Dubuque, IA (US); Katherine Rogers, Asbury, IA (US)

(21) Appl. No.: 16/443,965

(22) Filed: Jun. 18, 2019

(51) Int. Cl. E02F 9/22; F15B 1/02; F15B 1/027; F15B 11/10; F15B 1/08; E02F 3/76

(52) U.S. Cl. CPC E02F 9/2217; F15B 1/021; F15B 1/027; F15B 11/10; F15B 2211/7053; E02F 3/765; F15B 2201/205; F15B 2211/212; F15B 1/08

(57) ABSTRACT

The present disclosure relates to a gas-charged hydraulic accumulator assembly of a work vehicle, which is hydraulically coupled to a cap side chamber of a hydraulic cylinder. The gas-charged hydraulic accumulator assembly absorbs an impact from a work tool which increases a pressure of a first fluid in the cap side chamber. The gas-charged hydraulic accumulator assembly may include a first accumulator and a second accumulator. The first accumulator has a first gas and is used to receive the first fluid. The second accumulator is coupled to the first accumulator and has a second gas. The pressure of the second gas in a second pre-charged status is higher than a pressure of the first gas in a first pre-charged status. The second accumulator is used to receive the first fluid.

### RELATED APPLICATIONS

N/A.

### FIELD OF THE DISCLOSURE

The present disclosure relates generally to a hydraulic accumulator assembly that absorb kinetic energy from a work tool of a work vehicle.

### BACKGROUND OF THE DISCLOSURE

A work vehicle, such as a motor grader, is used for spreading and leveling dirt, gravel, or other materials. A work tool, such as a blade, is coupled to the rod end of hydraulic cylinder so as to raise or lower the work tool. In the process of grading, the blade may encounter a sudden impact, pressurizing a part of hydraulic oil in the hydraulic cylinder outflow from the head/cap of the hydraulic cylinder. The pressurized hydraulic oil may damage other hydraulic components in the hydraulic circuit. Therefore, a single accumulator is applied adjacent to the hydraulic cylinder. The single accumulator can only be adjusted its softness or rigidness through pre-charging; the operator needs to choose between a rigid mode and a soft mode. Once the softness or rigidness has been decided, that is applied to the work tool operation. If the operator chooses to have the soft mode in operation, that is, the pre-charged gas has a lower pressure, the operator may have comfortable feeling but the downstream components adjacent to the single accumulator may suffer damages because the single accumulator only absorbs limited amount of impact. On the other hand, if the operator chooses to have the rigid mode in operation, that is, the pre-charged gas has a higher pressure, the single accumulator may absorb stronger impacts to protect the downstream components but the operator may experience more impacts even if the impacts are weak.

### SUMMARY OF THE DISCLOSURE

According to an aspect of the present disclosure, a gas-charged hydraulic accumulator assembly of a work vehicle, which is hydraulically coupled to a cap side chamber of a hydraulic cylinder. The gas-charged hydraulic accumulator assembly is configured to absorb an impact from a work tool which increases a pressure of a first fluid in the cap side chamber. The gas-charged hydraulic accumulator assembly may include a first accumulator and a second accumulator. The first accumulator has a first gas and is configured to receive the first fluid. The second accumulator is coupled to the first accumulator and has a second gas. A pressure of the second gas in a second pre-charged status is higher than a pressure of the first gas in a first pre-charged status. The second accumulator is configured to receive the first fluid.

According to an aspect of the present disclosure, a work vehicle includes a frame, a ground engaging apparatus, a work tool, and a hydraulic system including at least one work tool moving circuit. The ground engaging apparatus is coupled to the frame and is configured to support the frame above a surface. The work tool is coupled to the frame. The at least one work tool moving circuit includes a hydraulic cylinder, a pressurized hydraulic fluid, a first control valve, and a gas-charged hydraulic accumulator assembly. The hydraulic cylinder includes a housing, a piston configured to reciprocally move within the housing and to divide a chamber of the hydraulic cylinder into a cap side chamber defining a bottom of the housing and a rod side chamber. The cap side chamber has a first fluid, and the rod side chamber has a second fluid. The piston is coupled to one end of a piston rod, and the other end of the piston rod is coupled to the work tool. The pressurized hydraulic fluid is configured to enter one of the cap side chamber and rod side chamber. The first control valve includes a plurality of first valve positions configured to selectively switch a direction of the pressurized hydraulic fluid entering the housing of the hydraulic cylinder to move the piston and configured to block the pressurized fluid from entering the housing of the hydraulic cylinder to substantially maintain a position of the work tool. The gas-charged hydraulic accumulator assembly is hydraulically coupled to the cap side chamber of the hydraulic cylinder and the first control valve therebetween. The gas-charged hydraulic accumulator assembly is configured to absorb an impact from the work tool which increases a pressure of the first fluid. The gas-charged hydraulic accumulator assembly includes a first accumulator and a second accumulator coupled to the first accumulator. The first accumulator has a first gas and is configured to receive the first fluid. The second accumulator has a second gas. A pressure of the second gas in a second pre-charged status is higher than a pressure of the first gas in a first pre-charged status. The second accumulator is configured to receive the first fluid.

According to an aspect of the present disclosure, a method for absorbing an impact from a blade of a motor grader to provide comfort for an operator and prevent mechanical damage, comprising: providing a gas-charged hydraulic accumulator assembly hydraulically coupled to a cap side chamber of a hydraulic cylinder and a piston rod of the hydraulic cylinder coupled to the blade; absorbing the impact from the blade so as to increase a pressure of a first fluid in the cap side chamber; providing a first accumulator of the gas-charged hydraulic accumulator assembly having a first gas and configured to receive the first fluid; and providing a second accumulator coupled to the first accumulator and having a second gas, a pressure of the second gas in a second pre-charged status being higher than a pressure of the first gas in a first pre-charged status and configured to receive the first fluid.

Other features and aspects will become apparent by consideration of the detailed description and accompanying drawings.

### BRIEF DESCRIPTION OF THE DRAWINGS

The detailed description of the drawings refers to the accompanying figures in which:

FIG. 1 is a side view of a motor grader;

FIG. 2A demonstrates a partial of hydraulic system in the motor grader;

FIG. 2B demonstrates another embodiment of a second control valve; and

FIG. 3 is a flow chart demonstrating a method for absorbing an impact from a blade of a motor grader to provide comfort for an operator and to prevent mechanical damage.

### DETAILED DESCRIPTION OF THE DRAWINGS

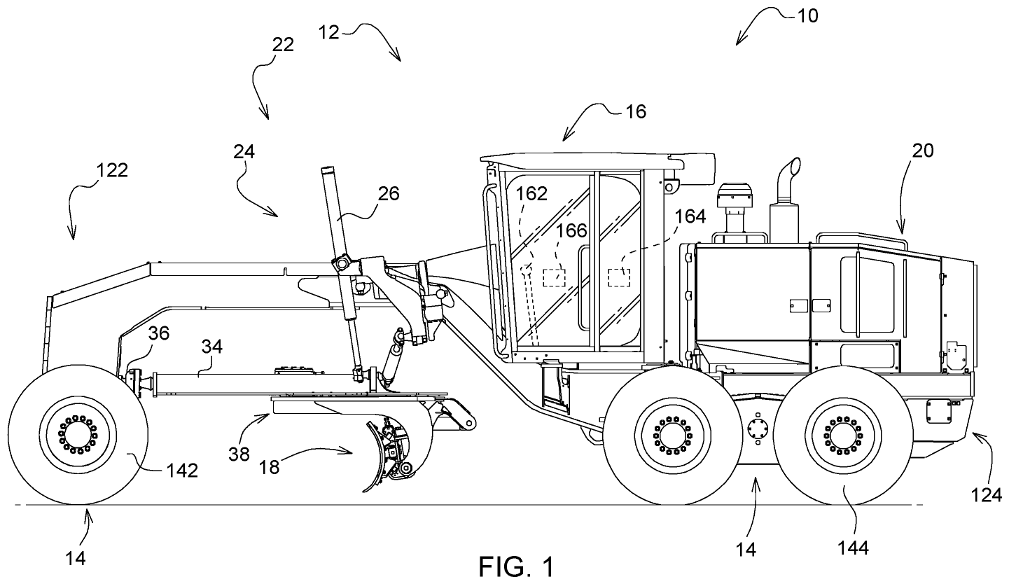

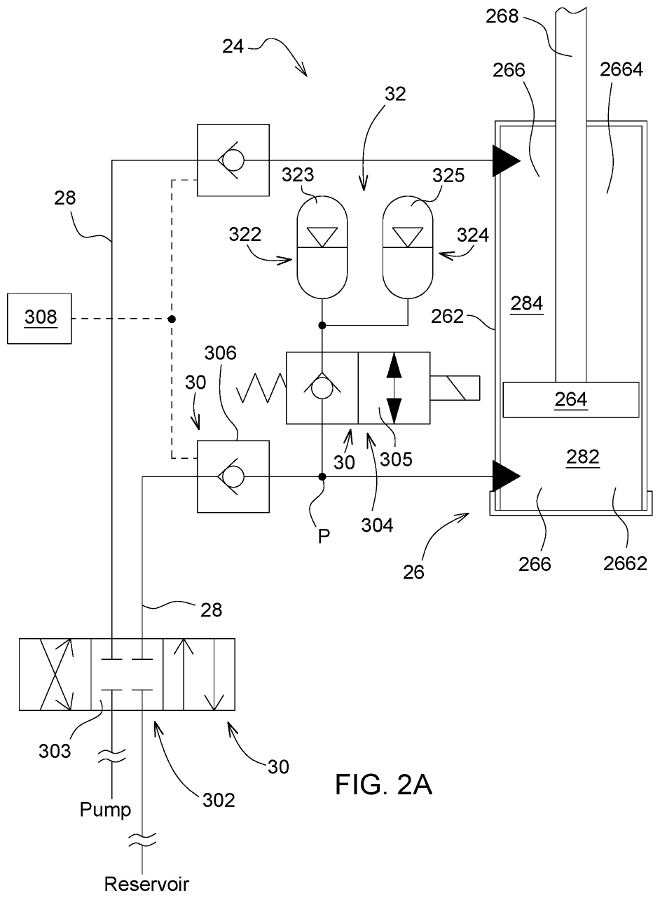

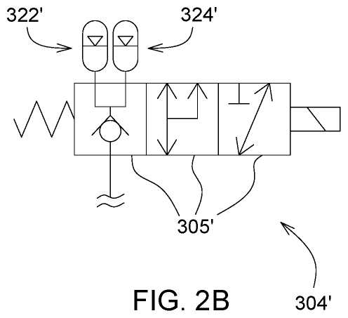

Referring to FIGS. 1 and 2A, a work vehicle 10 can be a motor grader. The work vehicle 10 includes a frame 12 and a ground engaging apparatus 14 coupled to the frame 12. The frame 12 includes a front frame 122 and a rear frame 124 in a fore-and-aft dimension. The ground engaging apparatus 14 in this embodiment are wheels, including a pair of front wheels 142 supporting the front frame 122 and a pair of tandem wheels 144 positioned on right and left sides of the work vehicle 10 and supporting the rear frame 124. An operator cab 16 is mounted on an upwardly and forwardly inclined rear region of the front frame 122 and contains various controls for the motor grader disposed so as to be within the reach of a seated or standing operator. These controls include a lever assembly 162 configured for steering and/or articulation controls, work tool input 164 configured for moving, shifting, rotating a work tool 18 that is coupled to the front frame 122 of the frame 12. The work tool 18 in this embodiment is a blade, configured for leveling and spreading. An engine 20 is coupled to the rear frame 124 and provides the driving power for driven components of the work vehicle 10. For example, the engine 20 is coupled to a transmission (not shown) which is further coupled to the tandem wheels 144 through tandem boxes (not shown) so as to propel the frame 12.

To move and power various components of the work vehicle 10, it includes a hydraulic system 22 having a plurality of cylinders that may be used, for example, to steer the front wheels 142, to articulate the work vehicle 10, and to move the work tool 18. In particular, the hydraulic system 22 includes at least one work tool moving circuit 24 coupled to the work tool 18. In this embodiment, the number of the work tool moving circuits 24 is two, and the two work tool moving circuits 24 are blade lift circuits. Each of the work tool moving circuits 24 includes a hydraulic cylinder 26, a pressurized hydraulic fluid 28, a plurality of valves 30, and a gas-charged hydraulic accumulator assembly 32.

The hydraulic cylinder 26 includes a housing 262, a piston 264 configured to reciprocally move within the housing 262 and to divide a chamber 266 of the hydraulic cylinder 26 into a cap side chamber 2662 and a rod side chamber 2664. The cap side chamber 2662 defines a bottom of the housing 262. The cap side chamber 2662 has a first fluid 282. The rod side chamber 2664 has a second fluid 284. The piston 264 is coupled to one end of a piston rod 268, and the other end of the piston rod 268 is coupled to the work tool 18. In this embodiment, the other end of the piston rod 268 is coupled to the work tool 18 via a drawbar 34 having a forward end universally connected to the front frame 122 by a ball and socket arrangement 36 and a circle group 38 coupled between the drawbar 34 and the work tool 18. When the pressurized hydraulic fluid 28 enters the cap side chamber 2662, the amount of the first fluid 282 increases and the cap side chamber 2662 expands, and therefore the second fluid 284 flows from the rod side chamber 2664 and the piston rod 268 moves downward to lower the work tool 18. On the contrary, when pressurized hydraulic fluid 28 enters the rod side chamber 2664, the amount of the second fluid 284 increases and the rod side chamber 2664 expands, and therefore the first fluid 282 flows from the cap side chamber 2662 and the piston rod 268 moves upward to lift the work tool 18. In operation, the pressurized hydraulic fluid 28 entering either the cap side chamber 2662 or rod side chamber 2664 are determined by a first control valve 302 of the valves 30. The first control valve 302 includes a plurality of first valve positions 303. For example, the first control valve 302 can be a four-ports-three-positions directional control valve, with two open positions and one closed neutral position. The two open positions of the first control valve 302 determine the pressurized hydraulic fluid 28 to enter the cap side chamber 2662 or the rod side chamber 2664. The closed position may allow the work tool 18 remain at the same location. The operator is able to utilize the work tool input 164 to switch different first valve positions 303 so as to control the lifting of the work tool 18. The plurality of first valve positions 303 described above are merely for illustration purpose. The various first valve positions 303 are used to selectively switch a direction of the pressurized hydraulic fluid 28 entering the housing 262 of the hydraulic cylinder 26 to move the piston 264 and also used to block the pressurized fluid 28 from entering the housing 262 of the hydraulic cylinder 26 to substantially maintain a position of the work tool 18.

The gas-charged hydraulic accumulator assembly 32 is hydraulically coupled to the cap side chamber 2662 of the hydraulic cylinder 26 and the first control valve 302 therebetween. The gas-charged hydraulic accumulator assembly 32 may be used to absorb an impact from the work tool 18. Such impact may result from, for example, a hard object like rock on the ground suddenly hitting the bottom of the work tool 18 (blade). The impact forces at least one of the hydraulic cylinder 26 to retract, which increases the pressure of the first fluid 282. If the gas-charged hydraulic accumulator assembly 32 is not arranged, the first fluid 282 with the sudden high pressure may damage other downstream components of the hydraulic system 22. It is noted that, in this embodiment, due to various factors, such as the hitting location of the work tool 18, the tilted angle of the work tool 18, the angle between the fore-and-aft dimension and the blade/work tool 18, and the direction of the travel of the work vehicle 10, the impact may push the work tool 18 moving upward asymmetrically. In other word, the two hydraulic cylinders 26 retract in different extents, the first fluids 282 from the two cap side chambers 2662 have different pressures, and therefore the two gas-charged hydraulic accumulator assemblies 32 receive different volumes of the first fluids 282.

In this embodiment, the valves 30 further include a second control valve 304 hydraulically coupled to the cap side chamber 2662 of the hydraulic cylinder 26. The second control valve 304 may be a solenoid valve. The second control valve 304 has a plurality of second valve positions 305 to control the first fluid 282 entering the gas-charged hydraulic accumulator assembly 32. The operator cab 16 may include an accumulator switch 166 that couples to the second control valve 304 so as to switch different second valve positions 305. As shown in FIG. 2A, one of the second valve positions 305 blocks the first fluid 282 from entering the gas-charged hydraulic accumulator assembly 32. Another one of the second valve positions 305 allows the first fluid 282 to enter at least one of a first accumulator 322 and a second accumulator 324 of the gas-charged hydraulic accumulator assembly 32, which will be described later. The operator may utilize the second control valve 304 to determine whether to use the gas-charged hydraulic accumulator assembly 32 to absorb the impact.

Each of the gas-charged hydraulic accumulator assembles 32 includes a first accumulator 322 and a second accumulator 324 coupled to the first accumulator 322. In this embodiment, the first and the second accumulators 322, 324 are diaphragm (bladder) type accumulators but can be other types of accumulators. In this embodiment, the first accumulator 322 has a first gas 323 elastically enclosed by a first bladder (not shown) and is configured to receive the first fluid 282. The second accumulator 324 has a second gas 325 elastically enclosed by a second bladder (not shown) and is also configured to receive the first fluid 282. Whenever the first accumulator 322 or the second accumulator 324 start to receive the first fluid, the volumes of the first gas 323 or the second gas 325 decrease and therefore the pressures of the first gas 323 or the second gas 325 increase. The first gas 323 and second gas 325 in this embodiment are nitrogen gas.

As described previously, the second control valve 304 has a plurality of second valve positions 305 to control the first fluid 282 entering the gas-charged hydraulic accumulator assembly 32. In the embodiment as shown in FIG. 2A, the second control valve 304 has two second valve positions 305. One of the second valve position 305 is configured to block the first fluid 282 from entering to the first accumulator 322 and the second accumulator 324. The other second valve position 305 is configured to allow the first fluid 282 received by the first accumulator 322 and the second accumulator 324, if the pressure of the first fluid 282 meets the requirement, which will be discussed later. It is noted that the second control valve 304′ in another embodiment allows the first fluid 282 flow to one, neither, or both accumulators 322′, 324′ depending on the operator's preference. For example, FIG. 2B demonstrates an embodiment of the second control valve 304′ having three second valve positions 305′. In the left position, the first fluid 282 is blocked. In the center position, the first fluid 282 can be received by the first accumulator 322′ and the second accumulator 324′, if the pressure of the first fluid 282 meets the requirement. In the right position, the first fluid 282 can only be received by the second accumulator 324′.

Before being pressurized by the first fluid 282, the pressure of the first gas 323 is in the first pre-charged status and the pressure of the second gas 325 is in the second pre-charged status. In the pre-charged status, the pressure of the second gas 325 is higher than the pressure of the first gas 323. The difference may be resulted from different gas volume during precharge, different materials of the bladders, different sizes of the first accumulator 322 and the second accumulator 324, etc. For demonstration purpose, the pressure of the first gas 323 in the first pre-charged status is 15 bar; the pressure of the second gas 325 in the second pre-charged status is 30 bar.

The following descriptions relates to the cooperation between the first accumulator 322 and the second accumulator 324 when the impact suddenly pushes the work tool 18 moving upward, under the condition that the user selects the second valve positions 305 of the second control valve 304 that allows the first fluid 282 to enter the gas-charged hydraulic assembly 32 (bi-direction position as shown in FIG. 2A).

When the strength of impact causes the first fluid 282 flowing from the cap side chamber 2662 and the pressure of the first fluid 282 is higher than the pressure of the first gas 323 in the first pre-charged status, the first accumulator 322 begins to receive the first fluid 282 that compresses the first gas 323. The pressure of the first gas 323 increases. However, when the strength of impact causes the first fluid 282 flowing from the cap side chamber 2662 and the pressure of the first fluid 282 is still lower than the pressure of the first gas 323 in the first pre-charged status, the first accumulator 322 does not receive the first fluid 282 and the pressure of the first gas 323 still remains the same or substantially constant (i.e. 15 bar).

When the pressure of the first gas 323, which increases after the first gas 323 is compressed by the first fluid 282, is still lower than the pressure of the second gas 325 in the second pre-charged status (i.e. 30 bar), the pressure of the second gas remains the same or substantially constant. In this situation, the second accumulator 324 does not receive the first fluid 282.

When the pressure of the first gas 323, which increases after the first gas 323 is compressed by the first fluid 282 is higher than the pressure of the second gas 325 in the second pre-charged status (i.e. 30 bar), the second accumulator 324 begins to receive the first fluid 282 that compresses the second gas 325 and the pressure of the second gas 325 increases. In this situation, both the first accumulator 322 and the second accumulator 324 receive the first fluid 282. However, if the pressure of the first gas 323 keeps increasing and reaches its maximum value, for example, 40 bar, the first accumulator 322 stops receiving the first fluid 282. The remaining first fluid 282 flows only to the second accumulator 324 until the second gas 325 reaches its maximum value, for example, 60 bar.

It is noted that because in this embodiment the number of the work tool moving circuits is two, the two gas-charged hydraulic accumulator assemblies 32 operate in responsive to the hydraulic cylinders of the same work tool moving circuits, and therefore the two gas-charged hydraulic accumulator assemblies 32 may operate independently. For example, for one of the gas-charged hydraulic accumulator assemblies 32, the first accumulator 322 and the second accumulator 324 both receive the first fluid 282, but for the other one of the gas-charged hydraulic accumulator assemblies 32, only the first accumulator 322 receives the first fluid. Such differences results from the impact asymmetrically applied on the work tool 18 and the two gas-charged hydraulic accumulator assemblies 32 operate accordingly.

As shown in FIG. 2A, the gas-charged hydraulic accumulator assembly 32 is hydraulically coupled to the cap side chamber 2662 of the hydraulic cylinder 26 and the first control valve 302 therebetween at a hydraulic connection point P. The work tool moving circuit 24 includes third control valves 306. The number of the third control valves 306 in this embodiment is two. One of the third control valve 306 is positioned between the rod side chamber 2664 and the first control valve 302; the other third control valve 306 is positioned between the hydraulic connection point P and the first control valve 302. The third control valves 306 in this embodiment are pilot operated check valves and the pilot input can determine whether to allow the pressurized hydraulic fluid 28, the first fluid 282 and/or the second fluid 284 flow back to the first control valve 302 or other downstream components. The third control valves 306 (pilot operated check valve) are controlled by a fourth control valve 308, the operation of which are determined by operation input, including but not limited to the lever assembly 162, work tool input 164. When the gas-charged hydraulic accumulator assembly 32 is used to prevent the future impact, at least the third control valves 306 between the hydraulic connection point P and the first control valve 302 is closed, such that the first fluid 282 will flow to the gas-charged hydraulic accumulator assembly 32.

Because the first accumulator 322 and the second accumulator 324 of the gas-charged hydraulic accumulator assembly 32 have different initial pre-charged pressures, the operator can choose to have relatively small vibration from the seat due to a weak impact absorbed by the first accumulator 322. If the impact is strong, the second accumulator 324 will cooperate with the first accumulator 322 to prevent downstream components from being damaged by the first fluid 282 resulted from the strong impact.

It is noted that the number of accumulators of the gas-charged hydraulic accumulator assembly 32 is only for the example. The gas-charged hydraulic accumulator assembly 32 can include a third accumulator (not shown) coupled to the first accumulator 322 and the second accumulator 324. The third accumulator has a third gas. A pressure of the third gas in a third pre-charged status is higher than the pressure of the second gas 325 in the second pre-charged status. Like the relationship between the first accumulator 322 and the second accumulator 324, the third accumulator may receive the first fluid 282 when the pressure of the first fluid 282 is higher than the pressure of the third gas in the third pre-charged status, no matter whether the second accumulator 324 stops receiving the first fluid 282.

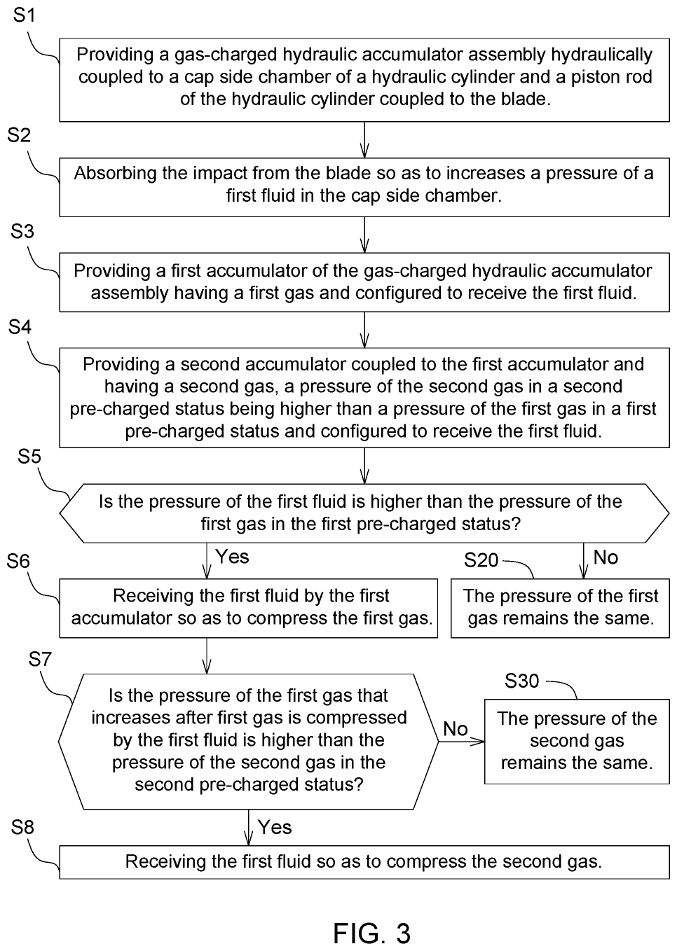

Referring to FIG. 3, the present disclosure also includes a method for absorbing an impact from a blade of a motor grader to provide comfort for an operator and prevent mechanical damage. The method comprising:

S1: Providing a gas-charged hydraulic accumulator assembly hydraulically coupled to a cap side chamber of a hydraulic cylinder and a piston rod of the hydraulic cylinder coupled to the blade.

S2: Absorbing the impact from the blade so as to increases a pressure of a first fluid in the cap side chamber.

S3: Providing a first accumulator of the gas-charged hydraulic accumulator assembly having a first gas and configured to receive the first fluid.

S4: Providing a second accumulator coupled to the first accumulator and having a second gas, a pressure of the second gas in a second pre-charged status being higher than a pressure of the first gas in a first pre-charged status and configured to receive the first fluid.

S5: Is the pressure of the first fluid is higher than the pressure of the first gas in the first pre-charged status? If yes, go to S6; if no, go to S20.

S6: Receiving the first fluid by the first accumulator so as to compress the first gas.

S7: Is the pressure of the first gas that increases after first gas is compressed by the first fluid is higher than the pressure of the second gas in the second pre-charged status? If yes, go to S8; if no, go to S30.

S8: Receiving the first fluid so as to compress the second gas.

S20: the pressure of the first gas remains the same or substantially constant.

S30: the pressure of the second gas remains the same or substantially constant.

It is noted that, in S1, if the embodiment includes two gas-charged hydraulic accumulator assemblies, each of them coupled to respective one of the two hydraulic cylinders, the two gas-charged hydraulic accumulator assemblies operate independently, such that the first and second accumulators of one of the two gas-charged hydraulic accumulator assemblies may absorb different amount of pressure from the amount absorbed by those of the other one of the two gas-charged hydraulic accumulator assemblies.

Without in any way limiting the scope, interpretation, or application of the claims appearing below, a technical effect of one or more of the example embodiments disclosed herein is absorb a sudden impact from the work tool. The at least two different accumulators in the gas-charged hydraulic accumulator assembly can serve to absorb impact better than a single accumulator. The cooperation between the at least two accumulators mitigates short, dynamic, and wide range responses at the work tool. Another technical effect of one or more of the example embodiments disclosed herein is to allow the operator to have comfortable feeling while the impact pushes the hydraulic cylinder. Another technical effect of one or more of the example embodiments disclosed herein is that even if the impact is strong, the operator can still have relative comfortable feeling and the downstream components are still protected.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A work vehicle, comprising:
a frame;
a ground engaging apparatus coupled to the frame and configured to support the frame above a surface;
a work tool coupled to the frame; and
a hydraulic system, comprising:
at least one work tool moving circuit, comprising:
a hydraulic cylinder comprising a housing, a piston configured to reciprocally move within the housing and divide a chamber of the hydraulic cylinder into a cap side chamber defining a bottom of the housing and having a first fluid and a rod side chamber having a second fluid, the piston coupled to one end of a piston rod, and the other end of the piston rod coupled to the work tool;
a pressurized hydraulic fluid configured to enter one of the cap side chamber and rod side chamber;
a first control valve comprising a plurality of first valve positions configured to selectively switch a direction of the pressurized hydraulic fluid entering the housing of the hydraulic cylinder to move the piston and configured to block the pressurized fluid from entering the housing of the hydraulic cylinder to substantially maintain a position of the work tool; and
a gas-charged hydraulic accumulator assembly hydraulically coupled to the cap side chamber of the hydraulic cylinder and the first control valve therebetween, the gas-charged hydraulic accumulator assembly configured to absorb an impact from the work tool which increases a pressure of the first fluid, the gas-charged hydraulic accumulator assembly comprising:
a first accumulator having a first gas and configured to receive the first fluid; and
a second accumulator coupled to the first accumulator and having a second gas, a pressure of the second gas in a second pre-charged status being higher than a pressure of the first gas in a first pre-charged status, and the second accumulator configured to receive the first fluid.

2. The work vehicle of claim 1, wherein when the pressure of the first fluid is higher than the pressure of the first gas in the first pre-charged status, the first accumulator begins to receive the first fluid that compresses the first gas, and the pressure of the first gas increases.

3. The work vehicle of claim 2, wherein when the pressure of the first gas that increases after being compressed by the first fluid is lower than the pressure of the second gas in the second pre-charged status, the pressure of the second gas remains substantially constant.

4. The work vehicle of claim 2, wherein when the pressure of the first gas, which increased after being compressed by the first fluid, is higher than the pressure of the second gas in the second pre-charged status, the second accumulator begins to receive the first fluid that compresses the second gas, and the pressure of the second gas increases.

5. The work vehicle of claim 4, wherein when the pressure of the first gas reaches a maximum value, the first accumulator stops receiving the first fluid.

6. The work vehicle of claim 1, further comprising a second control valve hydraulically coupled to the cap side chamber of the hydraulic cylinder, the second control valve having a plurality of second valve positions to control the first fluid entering the gas-charged hydraulic accumulator assembly.

7. The work vehicle of claim 6, wherein one of the second valve positions blocks the first fluid from entering the gas-charged hydraulic accumulator assembly and another one of the second valve positions allows the first fluid to enter at least one of the first accumulator and the second accumulator.

8. The work vehicle of claim 1, further comprising a third control valve hydraulically coupled to the cap side chamber of the hydraulic cylinder and the first control valve therebetween, wherein the gas-charged hydraulic accumulator assembly hydraulically coupled to the cap side chamber of the hydraulic cylinder and the first control valve therebetween at a hydraulic connection point, and the third control valve is positioned between the hydraulic connection point and the first control valve.

9. The work vehicle of claim 1, wherein the at least one work tool moving circuit includes two work tool moving circuits coupled to the work tool.

10. The work vehicle of claim 9, wherein the work vehicle is a motor grader and the work tool is a blade configured for ground grading, and the two work tool moving circuits are blade lift circuits.

11. A gas-charged hydraulic accumulator assembly of a work vehicle, which is hydraulically coupled to a cap side chamber of a hydraulic cylinder, the gas-charged hydraulic accumulator assembly configured to absorb an impact from a work tool which increases a pressure of a first fluid in the cap side chamber, the gas-charged hydraulic accumulator assembly comprising:
a first accumulator having a first gas and configured to receive the first fluid; and
a second accumulator coupled to the first accumulator and having a second gas, a pressure of the second gas in a second pre-charged status being higher than a pressure of the first gas in a first pre-charged status and the second accumulator configured to receive the first fluid.

12. The gas-charged hydraulic accumulator assembly of claim 11, wherein when the pressure of the first fluid is higher than the pressure of the first gas in the first pre-charged status, the first accumulator begins to receive the first fluid that compresses the first gas and the pressure of the first gas increases.

13. The gas-charged hydraulic accumulator assembly of claim 12, wherein when the pressure of the first gas, which increases after the first gas is compressed by the first fluid, is lower than the pressure of the second gas in the second pre-charged status, the pressure of the second gas remains substantially constant.

14. The gas-charged hydraulic accumulator assembly of claim 12, wherein when the pressure of the first gas, which increases after the first gas is compressed by the first fluid, is higher than the pressure of the second gas in the second pre-charged status, the second accumulator begins to receive the first fluid that compresses the second gas and the pressure of the second gas increases.

15. The gas-charged hydraulic accumulator assembly of claim 14, wherein when the pressure of the first gas reaches a maximum value of the pressure of the first gas, the first accumulator stops receiving the first fluid.

16. The gas-charged hydraulic accumulator assembly of claim 15, wherein when the pressure of the second gas reaches a maximum value of the pressure of the second gas, the second accumulator stops receiving the first fluid.

17. A method for absorbing an impact from a blade of a motor grader to provide comfort for an operator and prevent mechanical damage, comprising:
providing a gas-charged hydraulic accumulator assembly hydraulically coupled to a cap side chamber of a hydraulic cylinder and a piston rod of the hydraulic cylinder coupled to the blade;
absorbing the impact from the blade so as to increase a pressure of a first fluid in the cap side chamber;
providing a first accumulator of the gas-charged hydraulic accumulator assembly having a first gas and configured to receive the first fluid; and
providing a second accumulator coupled to the first accumulator and having a second gas, a pressure of the second gas in a second pre-charged status being higher than a pressure of the first gas in a first pre-charged status and configured to receive the first fluid.

18. The method of claim 17, further comprising
receiving the first fluid by the first accumulator so as to compress the first gas when the pressure of the first fluid is higher than the pressure of the first gas in the first pre-charged status.

19. The method of claim 18, further comprising
providing the second gas, the pressure of the second gas remaining constant when the pressure of the first gas, which increases after the first gas being compressed by the first fluid, is lower than the pressure of the second gas in the second pre-charged status.

20. The method of claim 18, further comprising
receiving the first fluid so as to compress the second gas when the pressure of the first gas, after the first gas being compressed by the first fluid, is higher than the pressure of the second gas in the second pre-charged status.
